(19) United States
(12) Patent Application Publication
(10) Pub. No.: US 2012/0273427 A1
(43) Pub. Date: Nov. 1, 2012

(54) SORBENT COMPOSITIONS AND METHODS OF USING SAME

(75) Inventors: Hongwen Gao, Shanghai (CN); Yulin Shen, Shanghai (CN); Shan Liu, Shanghai (CN)

(73) Assignee: Empire Technology Development LLC

(21) Appl. No.: 13/509,957

(22) PCT Filed: Jan. 20, 2011
(86) PCT No.: PCT/CN11/70414

§ 371 Date: May 15, 2012

(51) Int. Cl. C02F 1/28; B01J 20/30; B29C 47/00; B01J 20/22

(52) U.S. Cl. 210/681; 252/181; 252/178; 210/660; 210/691; 264/13

(57) ABSTRACT

Provided herein are compositions and methods for removing a variety of pollutants from wastewater. Such compositions are obtained by immobilizing barium-based hybrid materials, such as BaSO₄:APRB. Such compositions are easy to separate from the treated wastewater. After separation, the compositions, which include the pollutants, may be conveniently further separated from the pollutants and thus recovered for use again.

### FIELD

The technology generally relates to sorbent compositions for wastewater treatment.

### BACKGROUND

With increasing industrialization worldwide, there is a increased generation of polluted wastewater. Sources of such polluted water include printing and dyeing operations, and there is a need to clean and/or treat such wastewater.

Materials which include sulfate, barium salt, and acid red 138 (APRB) have been shown to be useful for removing various dyes and other organic pollutants from water. However, such hybrid materials can be problematic in certain ways. Being composed of nano-particles, it is easy to lose the hybrid material during wastewater treatment, and such hybrid materials are difficult to recover, recycle, and reuse.

### SUMMARY

In one aspect, provided herein is a sorbent composition including a hybrid material, and alginic acid or an alginic acid salt, wherein the hybrid material includes Ba²⁺, SO₄²⁻, and a sulfonated azo dye including a C₆-C₂₀ alkyl group. In another aspect, an article including the sorbent composition is provided. Such articles may include, but are not limited to, a cloth, a fiber, or a bead. In another aspect, the hybrid material may be prepared by contacting SO₄²⁻ with APRB in an aqueous solvent to provide a mixture and contacting the mixture with Ba²⁺. In another aspect, provided herein is a method including contacting an aqueous mixture including a pollutant with the sorbent composition provided herein and filtering the sorbent composition from the aqueous mixture, wherein after filtering, the concentration of pollutant in the aqueous mixture is reduced.

### DESCRIPTION OF THE DRAWING

FIG. 1 schematically illustrates a flow chart of preparing fiber compositions of the present technology, where 1 is a dissolving tank, 2 is a filter tank, 3 is a pulp storage barrel, 4 is a metering pump, 5 is a filter, 6 is a spinning nozzle, 7 is a coagulation bath, 8 is a drawing roller, 9 is a washing bath, and 10 is a winding roller.

### DETAILED DESCRIPTION

In the following detailed description, the illustrative embodiments described are not meant to be limiting. Other embodiments may be utilized, and other changes may be made, without departing from the spirit or scope of the subject matter presented here.

As used herein, unless otherwise stated, the singular forms “a,” “an,” and “the” include plural reference. As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

In one aspect, provided herein is a sorbent composition including a hybrid material, and alginic acid or an alginic acid salt, wherein the hybrid material includes Ba²⁺, SO₄²⁻, and a sulfonated azo dye including a C₆-C₂₀ alkyl group. The sulfonated azo dye may include a C₆-C₁₀ alkyl group, a C₁₁-C₁₆ alkyl group, or a C₁₇-C₂₀ alkyl group. Specific examples of C₆-C₂₀ alkyl groups include C₆, C₇, C₈, C₉, C₁₀, C₁₁, C₁₂, C₁₃, C₁₄, C₁₅, C₁₆, C₁₇, C₁₈, C₁₉, and C₂₀ alkyl groups. A specific example of a sulfonated azo dye is ARPB (weak Acidic Pink Red B). In one embodiment, the hybrid material is BaSO₄:ARPB (weak Acidic Pink Red B). The molar ratio of BaSO₄ to APRB can generally be any molar ratio. In another embodiment, a molar ratio of BaSO₄:APRB can be about 1:1 to about 20:1. In another embodiment, the molar ratio of BaSO₄:APRB can be about 5:1, about 10:1, about 15:1, or about 20:1, or ranges between any two of these values. In another embodiment, the molar ratio of BaSO₄:APRB is about 11:1. The concentration of alginic acid or alginic acid salt can generally be any concentration. In another embodiment, the ratio of hybrid material to alginic acid or alginic acid salt ranges from about 1:1 to about 4:1 on a wt % basis. In another embodiment, a ratio of hybrid material to alginic acid or alginic acid salt is about 1:1, about 2:1, about 3:1, about 4:1 on a wt % basis. In another embodiment, the ratio of hybrid material to alginic acid or alginic acid salt is about 2:1 on a wt % basis.

The sorbent composition may also include water as a solvent.

The sorbent composition includes alginic acid or an alginic acid salt. The concentration of alginic acid or alginic acid salt can generally be any concentration. According to various embodiments, the alginic acid or the alginic acid salt is present in the composition at about 1 wt/v % to about 10 wt/v %, at about 2 wt/v % to about 5 wt/v %, or at about 3 wt/v % to about 4 wt/v %. In another embodiment, the alginic acid or the alginic acid salt is present in the composition at about 1 wt/v % to 3 wt/v %, at about 4 wt/v % to about 6 wt/v %, or at about 7 wt/v % to about 10 wt/v %. In another embodiment, the alginic acid or the alginic acid salt is present in the composition at about 3 wt/v %.

The alginic acid salt can generally contain any cation or cations. In some embodiments, where the composition includes an alginic acid salt, the alginic acid salt includes an alkali metal, alkaline earth metal, or ammonium cation. In some embodiment, the alginic acid salt includes lithium ion, sodium ion, potassium ion, zinc, copper (2+), barium, or calcium ion as a cation. In another embodiment, the method further includes contacting the sorbent composition with a calcium salt. In one embodiment, the calcium salt is calcium chloride.

In another aspect, an article including the sorbent composition is provided. Such articles may include or take the form of, but are not limited to, a cloth, a fiber, or a bead.

In another aspect, the hybrid material may be prepared by contacting, a SO₄²⁻ ion source with APRB in an aqueous solvent to provide a mixture and contacting the mixture with a Ba²⁺ ion source. For example, the method may include contacting a source of SO₄²⁻ ion with a sulfonated azo dye including a C₆-C₂₀ alkyl group to provide a first mixture; contacting the first mixture with a Ba²⁺ source to provide a hybrid material; and contacting the hybrid material with alginic acid or an alginic acid salt to provide a sorbent composition. In some embodiments, the sulfonated azo dye including a C₆-C₂₀ alkyl group is weak acid pink red B (APRB). The source of SO₄²⁻ ion used in the method may include, but is not limited to, Na₂SO₄, K₂SO₄, CaSO₄, Al₂(SO₄)₃, or MgSO₄. The Ba²⁺ source used in the method may include, but is not limited to, BaCl₂, BaNO₃, or Ba(OH)₂.

In various embodiments, the molar ratio of BaSO₄:APRB is about 1:1 to 20:1. In some such embodiments, the molar ratio of BaSO₄:APRB is about 5:1, about 10:1, about 15:1, or about 20:1. In one embodiment, the molar ratio of BaSO₄:APRB is about 11:1.

In one embodiment of the method, a suspension of the BaSO₄-APRB hybrid material is added to a sodium alginate solution in a mass ratio of about 1:1 to about 2:1 of hybrid material:sodium alginate so that the final concentration of sodium alginate (mass/volume) is about 3%. Such a mixed solution called a spinning dope. The spinning dope is then filtered, de-aerated, and is then passed through a metering pump into a spinning nozzle in a calcium chloride coagulation bath. After coagulation and washing, fiber absorbing materials are obtained. The fiber absorbing materials may then be converted to woven or nonwoven cloth or used as fill filter materials. The non woven cloth may be prepared by wet-lay processes that allow the fibers to crosslink, in twisted rope fashion, or in the form of fibrous mats. Cloths of the present technology may also be prepared by EDC-activated crosslinking of hybrid alginate material of the present technology with polyethylene-imine and ethylenediamine. See, e.g., Chiu et al., Development of two alginate-based wound dressings. J. Mat. Sci. Mat. Med. , 2008, 19(6):2503-13.

Accordingly, in another embodiment, the method further includes spinning the sorbent composition to provide fibers. A variety of spinning methods, for example, and without limitation, electrostatic spinning may be used in accordance with the present methods.

The fiber absorbing materials thus prepared, can then be used to treat cationic dye wastewater to reduce the amount of residual dye pollutant in the water. In such treatments, a cationic dye wastewater may then be guided through the filter cloth to be separated and enriched. Alternatively, absorbing materials (0.05-1% solid) are directly added into a basin containing wastewater to be disposed. After the absorbing materials have absorbed the cationic dye from the wastewater, the materials are isolated. Thus, the fibers including the sorbent compositions provide a much more facile collection process after wastewater treatment, in comparison to nano-particulate recovery as described above. Fibers have a very high surface area to volume ratio, and are expected to provide favorable water treatment results.

Thus, in another aspect, the present technology provides a method including contacting an aqueous mixture including a pollutant with the sorbent composition provided herein and filtering the sorbent composition from the aqueous mixture, wherein after filtering the concentration of pollutant in the aqueous mixture is reduced. In one embodiment, the method includes providing an aqueous mixture comprising a pollutant at an initial pollutant concentration; providing a sorbent composition comprising a hybrid material comprising Ba²⁺, SO₄²⁻, and a sulfonated azo dye comprising a C₆-C₂₀ alkyl group; and alginic acid or an alginic acid salt; contacting the aqueous mixture and the sorbent composition; and filtering the sorbent composition from the aqueous mixture to prepare a filtered mixture having a final pollutant concentration; wherein the final pollutant concentration is lower than the initial pollutant concentration. The aqueous mixture has an initial pollutant concentration before contacting with the sorbent composition, and a final pollutant concentration after contacting with the sorbent concentration. The final pollutant concentration is lower than the initial pollutant concentration. For example, after filtering the amount of pollutant in the aqueous mixture is reduced by at least about 40 wt %, about 50 wt %, about 60 wt %, about 70 wt %, about 80 wt %, about 90 wt %, about 95 wt %, or about 99 wt %. In an ideal case, the amount of pollutant is reduced by 100% (that is, the final pollutant concentration is zero). In another embodiment, the pollutant includes a cationic dye compound. Illustrative cationic dyes may include, but are not limited to, ethyl violet (EV), methylene blue (MB), cationic red 3R (CR3R), cationic brilliant red 5GN (CBR), and the like.

After absorption of the pollutant by the sorbent composition, the resulting material, or article containing the material, may be collected and regenerated by using e.g., ethanol (50%-100%) or aqueous H₂SO₄ (1-4 mol/L). In some embodiments, ethanol is used for the regeneration, as it may be purified and recycled as well. Alternatively, the sorbent and bound pollutant may be disposed of together without regeneration.

In another embodiment, the pollutant may be other than a cationic dye and may include a persistent organic pollutant. Illustrative persistent organic pollutants include, but are not limited to, phenanthrene, fluorene, biphenyl, bisphenol A, and the like. In other embodiments, the pollutant includes polychlorinated biphenyls (PCBs), such as 2,4,5- Trichlorobiphenyl, 2,2′,4,5,5′-hexachlorobiphenyl, and 2,2′,3,4,4′,5,5′-heptachlorobiphenyl, and/or may include a pollutant such as microcystin-LR.

As used herein, “alkyl” groups are monovalent hydrocarbon radicals and include straight chain and branched alkyl groups having from 1 to about 30 carbon atoms, and typically from 1 to 20 carbons or, in some embodiments, from 1 to 10 carbon atoms. As also used herein, “alkyl groups” include cycloalkyl groups as defined below. Examples of straight chain alkyl groups include without limitation methyl, ethyl, n-propyl, n-butyl, n-pentyl, n-hexyl, n-heptyl, and n-octyl groups. Examples of branched alkyl groups include, without limitation, isopropyl, sec-butyl, t-butyl, neopentyl, and isopentyl groups. Alkyl groups may be unsubstituted or substituted. Representative substituted alkyl groups may be substituted one or more times with, for example, amino, carboxyl, thio, hydroxy, cyano, alkoxy, phenyl, and/or F, Cl, Br, and I groups.

As used herein, “alkoxy” refers to an —O-alkyl moiety. Examples of alkoxy groups include, without limitation, methoxy, ethoxy, isopropoxy, and benzyloxy.

As used herein, “aryl” refers to a mono, di, or tricyclic aromatic ring, which ring contains carbon atoms, or carbon and heteroatoms such as nitrogen, oxygen, and sulfur.

As used herein, “cationic dye” refers to a dye which contains a net positive charge.

As used herein, “cycloalkyl” groups are monovalent cyclic hydrocarbons. Examples of cyloalkyl groups include, without limitation, cyclopropyl, cyclobutyl, cyclopentyl, and cyclohexyl. Cycloalkyl groups may be unsubstituted or substituted.

As used herein, “persistent organic pollutant” refers to toxic chemicals that adversely affect human health and the environment. Examples of persistent organic pollutants include, without limitation, aldrin, chlordane, dichlorodiphenyl trichloroethane, dieldrin, endrin, heptachlor, hexachlorobenzene, mirex, toxaphene, polychlorinated biphenyls, polychlorinated dibenzo-p-dioxins, polychlorinated dibenzofurans, phenanthrene, flurorene, biphenyl, bisphenol A and such other aromatic compounds.

As used herein, a “sulfonated azo dye” refers to a dye containing to aryl groups joined by an —N═N— linker, and which contains at least one —SO₃H group or a salt thereof. Examples of azo dyes and sulfonated azo dyes are well known to a skilled artisan, and found for example, in Klaus Hunger, Industrial Dyes: Chemistry, Properties, Applications, Wiley-VCH (Mar. 7, 2003) ISBN: 3527304266. Azo dyes and sulfonated azo dyes are prepared according to well known synthetic methods, for example, and without limitation, by coupling an aryl diazonium salt with an amino, phenolic, or another nucleophilic aryl compound.

The present technology, thus generally described, will be understood more readily by reference to the following example, which is provided by way of illustration and is not intended to limit the present technology.

### EXAMPLES

### Example 1

### Synthesis of the BaSO₄:APRB hybrid material

The BaSO₄-APRB hybrid sorbent liquid was prepared by adding in aqueous components in the addition sequence: 1) SO₄²⁻; 2) APRB; 3) Ba²⁺, with molar ratios of 1.0:0.2:1.5. Using the same method, the BaSO₄:APRB surface-modified material was prepared in the sequence 1) ethanol; 2) SO4²⁻; 3) Ba²⁺; 4) APRB. The concentrations of APRB, Ba²⁺ and SO4²⁻ in the solid were determined by spectrophotometry using inductively coupled plasma optical emission spectrometer (ICP-OES) and ion chromatography (IC) after dissolving the solids in ethylene diamine tetraacetic acid and ammonia (EDTA-ammonia). The thermal gravimetric analysis (TGA) data, X-ray diffractometer (XRD) curves and scanning electronic microscopy (SEM) images of the powdered solid were collected, and zeta-potentials and size distributions were determined. Transmission electronic microscopy equipped with energy dispersive X-ray spectroscopy (TEM-EDX) was used to determine the distributions of different elements in the hybrid material. Basic pink red B was used to measure the isoelectric point and K_{d} of the hybrid material.

### Example 2

### Manufacture of a Fiber Including the Composition Containing a BaSO₄-APRB Hybrid Material

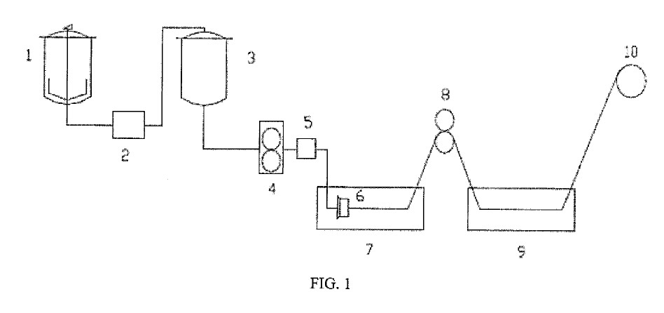

FIG. 1 schematically illustrates a flow chart of preparing fiber compositions as illustrated in this example. A suspension of the barium-based hybrid material was added to a sodium alginate solution in a mass ratio of 1:1 of BaSO₄:APRB to sodium alginate. The concentration of sodium alginate (m/v) was maintained at about 3% to provide a certain spinning viscosity. The mixture was then agitated mechanically for 4 hours to obtain an evenly mixed spinning dope and stored in a dissolving tank (1). Under nitrogen pressure, the spinning dope was passed through a filter (2) into a pulp storage barrel (3) and was de-aerated for 2 hours under vacuum. Under nitrogen, the spinning dope was passed through a metering pump (4) and a filter (5) to be ejected via a spinning nozzle (6) into a CaCl₂ coagulation bath (7) to produce fibers. The fibers were then drawn by a drawing roller (8), washed in a washing bath (9), wound in a winding roller 10, and dried to obtain calcium alginate immobilized BaSO₄:APRB fiber adsorbing materials.

### Example 3

### Effective Removal of Cationic Dyes From Jinjiang Wastewater

Jinjiang cationic dye wastewater (100 mL) with a chromaticity of 2158 and a chemical oxygen demand (COD) of 474 mg/L was added to each of four flasks. A fiber compositions as prepared in Example 2 was then added individually to the flasks such that samples containing, in wt/v %, 0.25%, 0.50%, 0.75%, and 1.0% of BaSO₄:APRB sorbent composition were prepared. The samples were then agitated on a shaking table for 2 hours. The fiber compositions were then filtered to obtain clear solutions. The chromaticity and the COD of the clear solution are presented in Table 1. As illustrated, a mere 0.5% of the fiber composition absorbs enough dye to reduce 80% of the color in the wastewater. After treating the wastewater, the resulting fiber composition containing the dye was easily separated.

TABLE 1

| | | | | COD |
|---|---|---|---|---|
| Addition of | Chromaticity/ | Chromatic | COD | Removal |
| Material | Degree | Removal Rate (%) | (mg/L) | Rate (%) |
| 0 | 2158 | — | 474 | — |
| 0.25% | 763.75 | 64.6 | 153 | 33.9 |
| 0.50% | 420.5 | 80.5 | 158 | 33.3 |
| 0.75% | 310.25 | 85.6 | 161 | 33.0 |
| 1.0% | 346.5 | 83.9 | 197.5 | 29.2 |

### Example 4

### Effective Removal of Cationic Dyes from Nantong Wastewater

Nantong cationic dye wastewater (100 mL) with a chromaticity of 242000 and COD of 5256 mg/L was added to five flasks. Fiber compositions were added to the flasks to prepare solutions, in wt/v %, 0.50%, 1.0%, 1.5%, 2.0%, and 3.0% of the BaSO₄:APRB sorbent composition. After shaking for 2 hours, the resulting fiber compositions are filtered to provide clear solutions. The chromaticity and the COD of the clear solutions are as shown in Table 2. A mere 3% of the fiber composition of the present technology absorbed enough dye to reduce 80% of the color in the wastewater.

TABLE 2

| | | Chromatic | | |
|---|---|---|---|---|
| Addition of | Chromaticity/ | Removal Rate | COD | COD Removal |
| Material | Degree | (%) | (mg/L) | Rate (%) |
| 0 | 242000 | — | 5256 | — |
| 0.50% | 195000 | 19.3 | 4084 | 22.3 |
| 1.0% | 160000 | 33.8 | 3748 | 28.7 |
| 1.5% | 114000 | 52.9 | 3104 | 40.98 |
| 2.0% | 74000 | 69.4 | 2732 | 48.0 |
| 3.0% | 40000 | 83.5 | 1968 | 61.9 |

### Example 5

### Regeneration of Sorbent Article and Cationic Dyes

After absorption of a cationic dye by the sorbent composition, the resulting sludge, or the article containing the cationic dye, may be collected. The article including the sorbent composition, and the cationic dye, can be regenerated by ethanol (50%400%) or aqueous H₂SO₄ (1-4 mol/L). When the sorbent regenerated at each cycle was used for cationic dye removal, the de-colorization rates of both ethyl violet and CBR wastewaters were still over 95%, and the chemical oxygen demand (COD) was decreased by more than 83%. Therefore, the recovered and regenerated sorbent retained the capacity to effectively remove pollutants from wastewater. Moreover, only about 5% of the solid sorbent material was lost in each recovery cycle. In contrast to conventional treatment methods, such as electrolysis and advanced oxidation, the hybrid sorbent did not destroy the structure of the cationic dye pollutant. The cationic dye included in the sludge is released (the sorbent and dye solution was separated by precipitating the sorbent) and is concentrated over 50-fold when the hybrid sorbent is regenerated. Thus, the released cationic dye may be extracted and recovered as a useful product for other dying processes.

### Example 6

### Preparation and Use of BaSO₄:APRB Beads

A. Preparation of BaSO₄:APRB Beads

A volume of a precursor solution was prepared by mixing sodium alginate powder (1% w/v) and BaSO4:APRB hybrid material (2% w/v) in deionized water. The mixture was vigorously stirred with a mechanical stirrer for 30 minutes, and then dripped through a syringe into a calcium chloride solution (2% w/v). The beads formed were cured in the calcium chloride bath for about 30 minutes, washed with deionized water, and collected. After freeze-drying, SEM images of the BaSO4:APRB containing beads were obtained using a Model Quanta 200 FEG scanning electron microscopy (FEI, USA).

B: Dye Absorption by BaSO₄:APRB Beads

The adsorption of the dyes, reactive brilliant red (K-2BP) and weak acid green (GS) as anionic dyes, and EV, MB, and CR3R as cationic dyes were tested. Solutions of the dyes (from 5 to 800 μmol/L) were prepared in deionized water, and 0.8 g of the wet BaSO4:APRB beads or pure alginate beads (control) were added to each dye solution (100 mL). After sorption, the concentrations of dyes in solution were determined by UV/VIS spectroscopy, using standard curves. The wavelengths selected were 595, 665, 548, 536, and 649 nm for EV, MB, CR3R, reactive brilliant red (K-2BP), and weak acid green (GS) respectively.

Four dyes were selected for testing the adsorption selectivity and adsorption mechanism of the BaSO₄:APRB beads: reactive brilliant red K-2BP, weak acid green GS, EV and MB. Samples were collected at appropriate time intervals and the concentrations were determined by spectrophotometer. A series of batch adsorption equilibrium experiments was carried out to determine adsorption isotherms of EV, MB and CR3R on sorbents. The beads were equilibrated in the bath at 25° C. for 24 hours to reach equilibrium. The sorbents were added into the dye solutions at various initial pHs or ionic strengths, and the mixtures were shaken on a rotary shaker with the rotation speed of 60 rpm for 24 hours. The solution pH was then determined. The equilibrium solution concentrations were then measured by UV/VIS. The adsorption efficiency was expressed in terms of percentage (R, %) and calculated as follows:

$$R = \frac{{C}_{0} - {C}_{e}}{{C}_{0}} \times 100$$

where, C₀ and Cₑ (mg/L) are the initial and equilibrium solution concentrations of dyes. The adsorption amount Q at equilibrium was calculated by:

$$Q = \frac{( {C}_{0} - {C}_{e} ) \times V}{m}$$

where Q is the amount of dye sorbed (mg/g) onto a unit dry mass of the beads, V is the volume of the dye solution (L) and m the dry weight of the beads used (g).

EV and MB solutions were almost colorless and transparent after treatment with BaSO₄:APRB beads, while the anionic dyes were adsorbed by the BaSO₄:APRB beads to a minimal extent. The adsorption capacity of BaSO₄:APRB beads for MB and EV was higher compared to the control beads. No substantial influence of pH on dye removal was observed for the BaSO4:APRB beads. The removal of MB by the BaSO₄:APRB decreased from 96% to 78%, when NaCl concentration varied from 0 to 0.1 mol/L. However, at 0.1 M NaCl, the control beads removed only 40% of MB, making the BaSO₄:APRB beads more suitable for practical removal of dye-containing wastewater.

C. Effective Removal of Dyes from Dye Containing Wastewater by BaSO₄:APRB Beads:

The BaSO4:APRB beads was used to treat cationic dye containing wastewater from two sources. After treatment with the BaSO4:APRB beads, the color of the wastewater decreased with increasing of sorbent content. The two wastewater samples were decolorized by more than 80% (w/v) when 0.5% (w/v) of the beads or with 3% of the beads. Where APRB was found to leach out of the hybrid material, when treated with one of the wastewaters, such leaching was avoided by preparing the hybrid material with less APRB, e.g., about 25% less APRB.

### EQUIVALENTS

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms ‘comprising,’ ‘including,’ ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compounds, compositions, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, or compounds, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Finally, as will be understood by one skilled in the art, a range includes each individual member.

Other embodiments are set forth in the following claims.

1. A sorbent composition comprising:
a hybrid material comprising Ba²⁺, SO₄²⁻, and a sulfonated azo dye comprising a C₆-C₂₀ alkyl group; and
alginic acid or an alginic acid salt.

2. The sorbent composition of claim 1, wherein the hybrid material is BaSO₄:APRB (weak Acidic Pink Red B).

3. The sorbent composition of claim 2, wherein a molar ratio of BaSO₄:APRB is about 1:1 to about 20:1.

4. The sorbent composition of claim 1, wherein a wt % ratio of hybrid material to alginic acid or alginic acid salt is about 1:1 to about 4:1.

5. The sorbent composition of claim 1, wherein the hybrid material is prepared by contacting SO₄²⁻+with APRB to provide a mixture, and contacting the mixture with Ba^{a}²⁺.

6. The sorbent composition of claim 1, further comprising water.

7. The sorbent composition of claim 6, wherein the alginic acid or the alginic acid salt is present in the composition at about 1 wt/v % to about 10 wt/v.

8. The sorbent composition of claim 1, further comprising calcium ions.

9. An article comprising a hybrid material comprising Ba²⁺, SO₄²⁻, and a sulfonated azo dye comprising a C₆-C₂₀ alkyl group; and
alginic acid or an alginic acid salt.

10. The article of claim 9, wherein the hybrid material is BaSO₄:APRB (weak Acidic Pink Red B).

11. The article of claim 10, wherein a molar ratio of BaSO₄:APRB is about 1:1 to about 20:1.

12. The article of claim 9, wherein a wt % ratio of hybrid material to alginic acid or alginic acid salt is about 1:1 to about 4:1.

13. The article of claim 9, wherein the hybrid material is prepared by contacting SO₄²⁻ with APRB to provide a mixture, and contacting the mixture with Ba²⁺.

14. The article of claim 9, further comprising calcium ions.

15. A cloth or fiber article comprising:
a hybrid material comprising Ba²⁺, SO₄²⁻, and a sulfonated azo dye comprising a C₆-C₂₀ alkyl group; and
alginic acid or an alginic acid salt

16. The article of claim 15, wherein the hybrid material is BaSO₄:APRB (weak Acidic Pink Red B).

17. The article of claim 16, wherein a molar ratio of BaSO₄:APRB is about 1:1 to about 20:1.

18. The article of claim 15, wherein a wt % ratio of hybrid material to alginic acid or alginic acid salt is about 1:1 to about 4:1.

19. The article of claim 15, wherein the hybrid material is prepared by contacting SO₄²⁻ with APRB to provide a mixture, and contacting the mixture with Ba²⁺.

20. The article of claim 15, further comprising calcium ions.

21. A method of manufacturing a sorbent composition, the method comprising:
contacting a SO₄²⁻ ion source with a sulfonated azo dye comprising a C₆-C₂₀ alkyl group to provide a first mixture;
contacting the first mixture with a Ba²⁺ ion source to provide a hybrid material; and
contacting the hybrid material with alginic acid or an alginic acid salt to provide a sorbent composition.

22. The method of claim 21, wherein the sulfonated azo dye is weak acid pink red B (APRB).

23. The method of claim 21, wherein a molar ratio of BaSO₄:APRB is about 1:1 to about 20:1.

24. The method of claim 21, wherein a wt % ratio of hybrid material to alginic acid or alginic acid salt is about 1:1 to about 4:1.

25. The method of claim 21, wherein the contacting with the alginic acid or the alginic acid salt is performed in an aqueous solvent.

26. The method of claim 21, wherein the alginic acid or the alginic acid salt is present in the composition at about 1 wt/v % to about 10 wt/v.

27. The method of claim 21, further comprising spinning the sorbent composition to provide fibers.

28. The method of claim 21, further comprising contacting the sorbent composition with a calcium salt.

29. A method of removing pollutants from a mixture, the method comprising:
providing an aqueous mixture comprising a pollutant at an initial pollutant concentration;
providing a sorbent composition comprising a hybrid material comprising Ba²⁺, SO₄²⁻, and a sulfonated azo dye comprising a C₆-C₂₀ alkyl group; and alginic acid or an alginic acid salt;
contacting the aqueous mixture and the sorbent composition; and
filtering the sorbent composition from the aqueous mixture to prepare a filtered mixture having a final pollutant concentration;
wherein the final pollutant concentration is lower than the initial pollutant concentration.

30. The method of claim 29, wherein the pollutant comprises a cationic dye or a persistent organic pollutant.
